(19) United States
(12) Patent Application Publication
(10) Pub. No.: US 2014/0257839 A1
(43) Pub. Date: Sep. 11, 2014

(54) Online Lens Ordering System for Vision Care Professionals or Direct to Customers

(71) Applicant: Pro Fit Optix Inc., Irving, TX (US)

(72) Inventors: Rudolf Suter, Dallas, TX (US); Jagdish M. Jethmalani, Irving, TX (US); Steve R. Brewer, Denton, TX (US)

(73) Assignee: Pro Fit Optix Inc., Irving, TX (US)

(21) Appl. No.: 14/199,393

(22) Filed: Mar. 6, 2014

Related U.S. Application Data
(60) Provisional application No. 61/774,550, filed on Mar. 7, 2013.

(51) Int. Cl. G06Q 50/22; G06Q 30/06

(52) U.S. Cl. CPC G06Q 50/22; G06Q 30/0633
USPC 705/2

(57) ABSTRACT

A computerized online lens ordering system is provided. A patient portal allows a user to enter identifying information and/or healthcare plan information and a purchase selection for eyeglasses and/or contact lenses. A vision plan eligibility module submits claims to an insurer based upon the healthcare plan information, determines an amount due by the patient, if any, based upon the purchase selection, receives any payment due and authorizes an order. An fulfillment module, for eyeglasses, obtains the patient's prescription and frame biometric measurements, produces a lens fabrication pattern for the lenses, automatically orders the selected frame and fabrication of the lenses based upon the fabrication pattern, and delivers a fabricated pair either directly to the patient or to an eye care professional business. For contact lenses, the fulfillment module automatically orders delivery of the contact lenses either directly to the patient or to an eye care professional business.

### CROSS-REFERENCE TO RELATED APPLICATIONS

This application claims the priority, under 35 U.S.C. §119, of copending U.S. Provisional Patent Application No. 61/774,550, filed Mar. 7, 2013; the prior application is herewith incorporated by reference herein in its entirety.

### TECHNICAL FIELD OF THE INVENTION

The present invention relates in general to eyewear and/or contact lenses and, in particular, to a system for providing eyewear and/or contact lenses.

### BACKGROUND OF THE INVENTION

Eyeglasses and contact lenses have long been provided for correcting vision. An eye exam and prescription are required for purchasing corrective eyeglasses and/or contact lenses. Often, such purchases are covered by vision care insurance offered by health insurance carriers. Patients typically purchase eyeglasses or contact lenses from stores attended by eye care professionals who assist in the selection and fitting of eyeglasses, and/or in the selection of contact lenses. Eye care professionals also assist in verifying vision care insurance coverage and assisting in obtaining insurance coverage payments. The personal attention of eye care professionals increases the costs that the purchasers are required to pay for eyeglasses and contact lenses. Automation of this process would greatly reduce costs required for obtaining eyeglasses and/or contact lenses.

Thus, a need exists to overcome the problems with the prior art discussed above.

### SUMMARY OF THE INVENTION

The invention provides an online system for ordering and providing eyewear and/or contact lenses that overcomes the hereinafore-mentioned disadvantages of the heretofore-known devices and methods of this general type and that provide such features with a patient portal provided for use on a personal computing device or an in-store kiosk or a handheld device (tablet or smartphone) or any other communication device. A patient enters identifying information and, optionally, healthcare plan information and either eyeglasses or contact lenses are selected using the lens ordering system. The identifying information can include, but is not limited to, all contact data for the patient and/or the eye care professional, all factual data sufficient to fulfill the patient's vision prescription, and/or any other information that is necessary to process an eyewear and/or contact lens order. The healthcare plan information can include, but is not limited to, all contact data for the patient and/or the eye care professional, all contact data for the professional (physician/optician/etc.) who provided and/or generated the prescription, all contact data for the healthcare plan provider (i.e., insurer), and/or information sufficient to submit a claim with the healthcare plan provider.

The lens ordering system then determines vision plan eligibility, submits a claim, determines an amount due, and receives payment the amount due from the patient. For eyeglasses, frames are automatically sized for the patient using a vision system with a known frame size to capture patient frame biometric measurements. Lens sets for eyeglasses may be automatically produced by 3D printing, freeform processing or other known methods. Eyeglasses and contact lenses orders are placed for fabrication and delivered either directly to the patient or to an eye care professional business. A payment portal for accepting credit card or other methods of payment can be accessed for making the purchase of eyeglasses or contact lenses.

With the foregoing and other objects in view, there is provided, in accordance with the invention, an online lens ordering system comprising a computer providing a patient portal, a vision plan eligibility module, and a fulfillment module. The patient portal allows a user to enter at least one of identifying information and healthcare plan information and a purchase selection for one of eyeglasses including a prescription, a selected frame and lenses to be fabricated and contact lenses including a prescription. The vision plan eligibility module submits claims to an insurer based upon the healthcare plan information, determines an amount due by the patient, if any, based upon the purchase selection, and receives payment of the amount due from the patient if an amount is due and then setting an order authorization and/or sets the order authorization if an amount is not due. The fulfillment module, upon receiving the order authorization for eyeglasses obtains the patient's prescription and frame biometric measurements and automatically orders the selected frame and fabrication of the lenses based upon the prescription and delivering a fabricated pair of the eyeglasses either directly to the patient or to an eye care professional business. Upon receiving the order authorization for contact lenses, the fulfillment module, automatically orders delivery of the contact lenses based on the prescription either directly to the patient or to an eye care professional business.

With the objects of the invention in view, there is also provided an online lens ordering system, comprises a patient portal is provided for use on a personal computing device, an in-store kiosk, and/or a handheld device, wherein a patient enters identifying information and optional healthcare plan information, and either eyeglasses or contact lenses are selected using the lens ordering system, means for determining vision plan eligibility, submitting claims, submitting a prescription, and determining an amount due, and receiving payment the amount due from the patient, means for automatically sizing eyeglasses for a patient, using a vision system with a known frame size to capture patient frame biometric measurements, and means for ordering fabrication and delivery of eyeglasses and/or contact lenses either directly to the patient or to an eye care professional business.

In accordance with another feature of the invention, the computing device is a personal computing device, an in-store kiosk, and/or a handheld device, such as a tablet or a smartphone.

In accordance with a further feature of the invention, the patient portal is an Internet connection enabling the user to access information, sites, programs, and databases available through the Internet.

In accordance with an added feature of the invention, the identifying information includes at least one of contact data for a patient, patient identification, contact data for an eye care professional, a National Provider Identifier number, contact data for a user, and/or factual data sufficient to verify eligibility to fulfill the patient's vision prescription.

In accordance with an additional feature of the invention, the healthcare plan information includes at least one of contact data for the patient, a plan number, an employee number, a patient identification number, contact data for the eye care professional, contact data for the professional who provided and/or generated the prescription, contact data for the healthcare plan provider, and/or information sufficient to submit a claim with the healthcare plan provider.

In accordance with yet another feature of the invention, the vision plan eligibility module interfaces with an insurer through the Internet to submit the claim and determine if any amount is due by the patient.

In accordance with yet a further feature of the invention, the fulfillment module sends the order authorization to an automated lens production module that accesses manufacturers' databases for frame data to fabricate the lenses.

In accordance with yet an added feature of the invention, the fulfillment module retrieves frame measurement data from a database, the frame tracer, or the identifying information and utilizes the frame measurement data along with the prescription to fabricate the lenses.

In accordance with yet an additional feature of the invention, the fulfillment module is communicatively connected to a lens fabrication device that fabricates based upon the prescription and frame measurement data.

In accordance with again another feature of the invention, the fulfillment module is communicatively connected to a frame tracing device that creates frame data by scanning the selected frame from an inventory and utilizes the frame data and the prescription for fabricating the complete eyewear.

In accordance with again a further feature of the invention, the fulfillment module is communicatively connected to a lens fabrication device that fabricates based upon the frame data and the prescription.

In accordance with again an added feature of the invention, the automated lens production module is communicatively connected to off-site lens fabrication labs through the Internet.

In accordance with again an additional feature of the invention, the fulfillment module is communicatively connected to a contact lens distribution site through the Internet and automatically populates data into data entry fields of the contact lens distribution site.

In accordance with still another feature of the invention, the contact lens distribution site is a contact lens distributor or a contact lens manufacturer.

In accordance with still a further feature of the invention, the fulfillment module is communicatively connected to laboratory management software and obtains real-time status updates on orders submitted.

In accordance with still an added feature of the invention, the identifying information includes factual data sufficient to fulfill the patient's vision prescription and the patient portal module is communicatively connected to a prescription verification site through the Internet and verifies the patient's vision prescription.

In accordance with still an additional feature of the invention, the fulfillment module automatically captures the patient's frame biometric measurements with a pre-determined frame using a vision detecting system and, based upon the patient's prescription and biometric measurements taken, produces the complete eyewear.

In accordance with another feature of the invention, the fulfillment module automatically captures the patient's frame biometric measurements by acquiring a reference frame of known geometry provided for positioning on the patient, the fulfillment module having access to the dimensions of the reference frame, stores images from at least two directions of the patient while wearing the reference frame, and processes the images to determine the patient's frame biometric measurements.

In accordance with a further feature of the invention, the frame biometric measurements comprise values for pupil distance, SEG height, vertex distance, and pantoscopic angle and tilt.

In accordance with an added feature of the invention, there is provided an automatic eyeglass sizing device automatically sizing eyeglasses for a patient, the automatic eyeglass sizing device comprising a neural network and an associated database containing frame sizing and fit data.

In accordance with a concomitant feature of the invention, a lens fabrication device automatically producing lenses, the lens fabrication device comprising at least one of 3D printing processes, freeform processing, and/or molding processes.

Although the invention is illustrated and described herein as embodied in an online system for providing eyewear and/or contact lenses, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block diagram of an online lens ordering system for vision care professionals or for patients to place orders for direct customer sales;

FIGS. 2A-2C together provide a process flow diagram showing operation of the vision acquisition system;

FIG. 3 is a flow chart showing a process for a patient selecting a frame;

FIG. 4 is flow chart depicting a process for automatic collection of patient frame biometric measurements; and

FIG. 5 is a process flow diagram depicting a process of a vision fulfillment system and method.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The online system is a web portal that is developed based on the business rules and logic and comprises database tables, a user interface(s), web services (to submit requests and communicate with databases/portal to provide data/information that is desired), an application programming interface(s) (API, to manage web services to communicate with other database/portal), validation rules, and exceptions. Hosting of the website is managed, for example, on cloud servers with back up facilities so that the website does not suffer from any down time. Security and HIPAA and PCI compliance are necessary while hosting website so that patient privacy and credit card data transactions are safely and securely transmitted.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

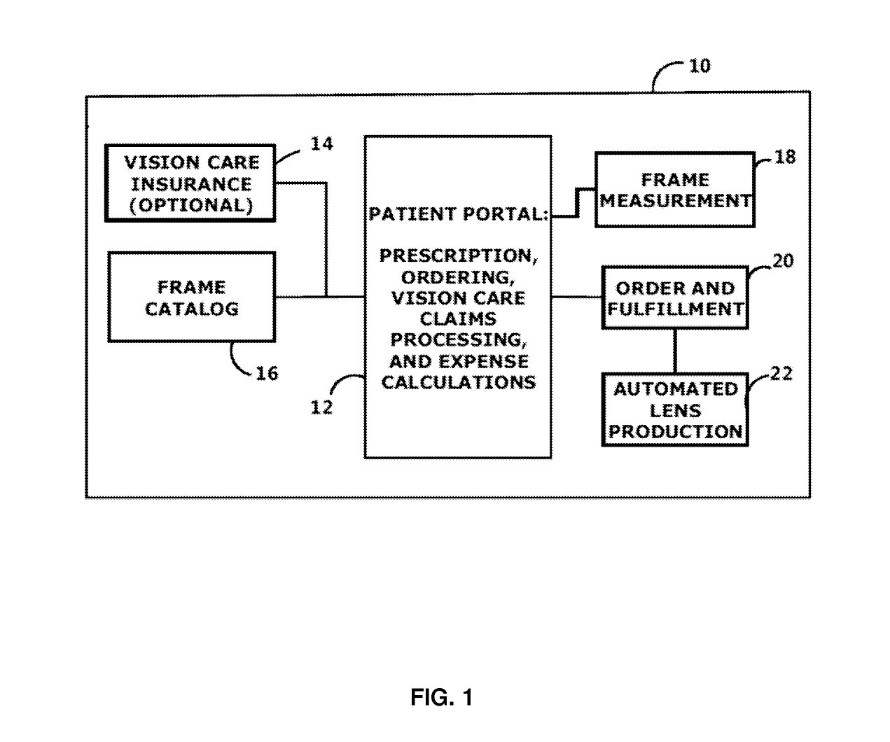

Described now are exemplary embodiments of the present invention. Referring now to the figures of the drawings in detail and first, particularly to FIG. 1, there is shown a first exemplary embodiment of an online lens ordering system 10 for vision care professionals or for patients to place orders for direct customer sales. The ordering system 10 is, in this exemplary embodiment, embodied in various devices and in computer software stored in machine readable memory for operating on one or more computer processors and accessible memory, as illustrated in several modules. The ordering system 10 has a patient or client portal 12 receiving patient prescriptions, ordering eyeglasses or contact lenses, placing claims for vision care insurance policies, and processing vision care claims to determine coverage eligibility and patient expense calculation. The lens ordering system 10 further includes access to an optional vision care insurance module 14 interfacing with insurance providers and determining coverage and eligibility of claims, and a frame catalog module 16 interfacing with and obtaining frame information from various manufacturers. The patient portal 12 interfaces with the frame measurement module 18 and interfaces with an order and fulfillment module 20. The order fulfillment module 20 then interfaces with an automated lens production module 22. In an exemplary embodiment, the frame measurement module 18 includes access to manufacturers' databases for frame measurement, automated equipment for measuring frame geometry, and vision systems automatically measuring patient frame biometric data when a frame of known geometry is selected by a patient. The automated lens production 22 may include 3D printing of lenses, freeform processing, molding, and other such production processes. Freeform processing includes using freeform generator and polisher which have multi-axis cutting and polishing capabilities to create lenses with a desired prescription. Lens generation using 3D printing may include depositing liquid melt polycarbonate material on to a curved mold, whose radius is selected to be either spherical or aspherical, until a desired profile and thickness is reached that matches the desired prescription. The desired prescription can be determined by utilizing a software algorithm that designs the front and back surfaces along with the desired thickness so that the optical element created provides the correct refracting power in specific regions of the lens.

The interface between the patient portal 12 and the frame catalog 16 may be a web service communication to a frame manufacturer database. Alternately the frame can be one that is available at the eye care professional location and which is measured to fit the patient, the data being transferred after tracing the frame with a commercial frame tracer or laser tracer that is described, for example, in U.S. patent application Ser. No. 14/018,311 to Hofineister, filed Sep. 4, 2013, which is incorporated by reference herein. The vision care insurance 14 may be an on-line portal where the eye care professional verifies patient eligibility and submits online eyewear prescription order. Frame measurements 18 may be entered directly into the fields on the portal or can be transferred directly through devices that measure the frame biometric information that is related to frame geometry and pupil location to provide the segment height, pupil distance, etc. Alternately, the doctor's office or store front is supplied with a set of 24, 36, 48, 60, 72, or a predetermined number of frames that are displayed on the web portal. The patient or eye care professional can select one of these frames and submit that selected frame along with the prescription order so that the optical lab can manufacture the prescription lenses and edge and mount lenses in the selected frame to provide a complete pair of eyeglasses directly to the eye care professional or to the patient. Another method is to send the frame measurement 18 along with the prescription at the time of submitting the order by filling the necessary information in the web portal fields and the optical lab selects the same frame from their inventory to manufacture complete eyewear without the need of shipping the frame from the eye care professional to the optical lab. Additional features of the web portal is that it is capable of submitting a prescription order directly to labs both globally and regionally to reduce the amount of time it takes to deliver the completed eyeglasses. In case of contact lenses, the fulfillment can be achieved by either a distributor or directly from the manufacturer. The order submission format may follow the Vision Council of America (VCA) standard or a custom format as the lab desires. Data transfer and population into the inventive web portal from prior art online order submission web portals (Vision Web, etc.) without the feature of vision claim submission or practice management software (such as OfficeMate, Eyecare Advantage, MaximEyes and the like) into the inventive web portal may be through XML transfer or similar processes, whereby the data is automatically populated into the order portal's specific fields. Another desired benefit is an interface with Laboratory Management Software (such as DVI, Ocuco, Innovations and the like) so that the ordering entity can obtain real-time status updates on the submitted orders, for example, to allow the eye care professional time to setup an appointment to dispense the eyeglasses to a patient.

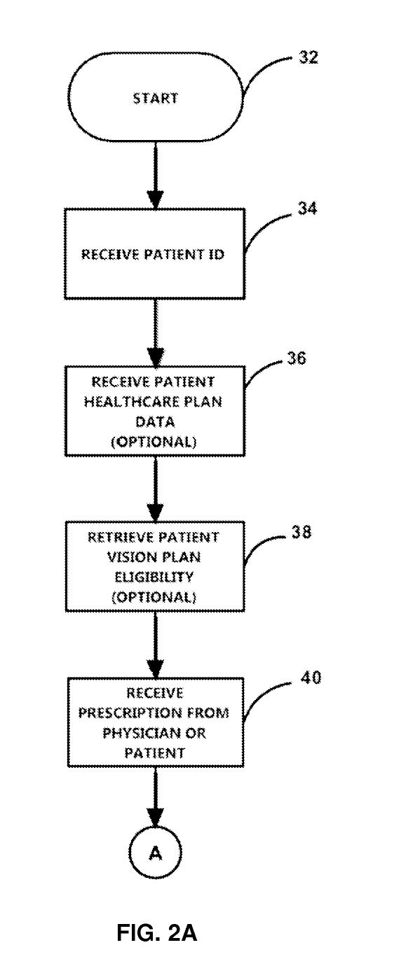

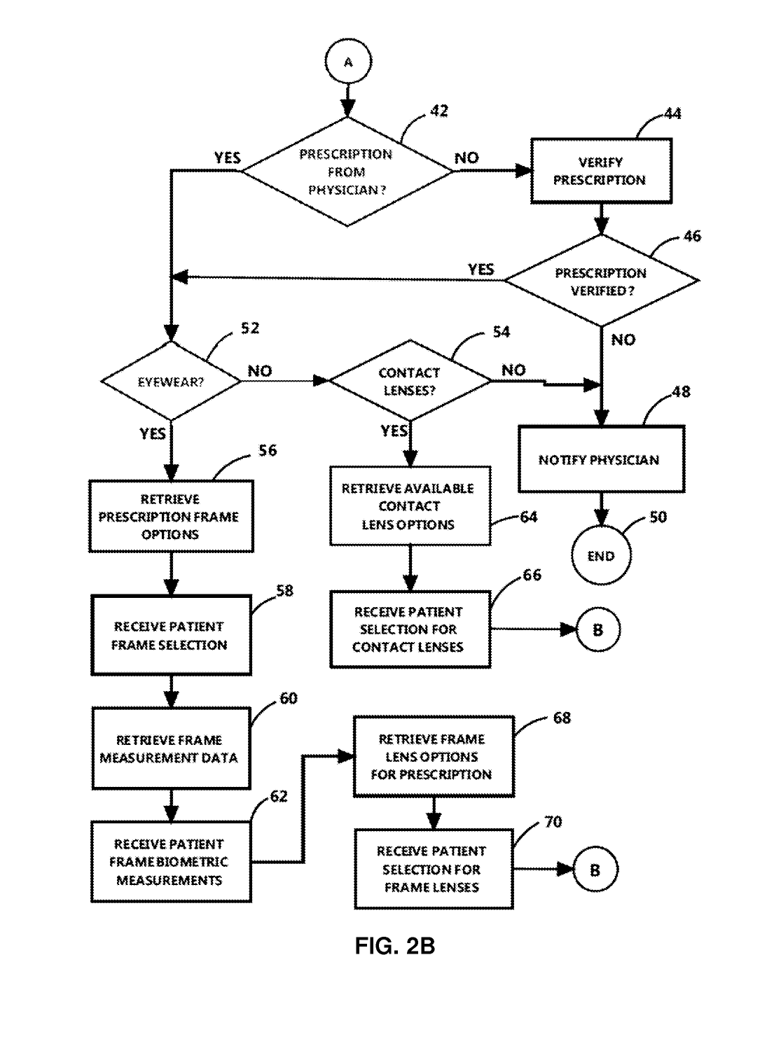

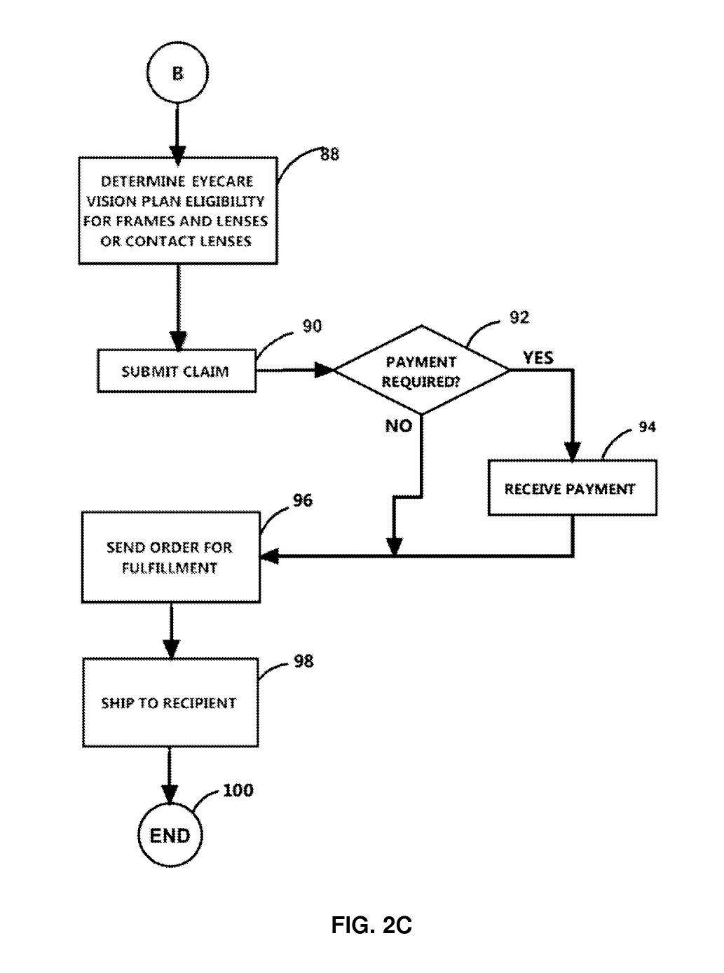

FIGS. 2A-2C together provide a process flow diagram showing an exemplary embodiment of operation of the vision acquisition system. The process starts in step 32 and then proceeds to step 34 in which a patient enters a patient ID. Patient healthcare plan data is then entered in step 36, which information includes, for example, a plan number, an employee number, and/or a patient identification number under the healthcare plan. Then, in step 38, the system accesses a vision care insurance database of the healthcare provider and determines whether the patient has vision plan eligibility and the amount of such eligibility. Alternatively, in steps 34 to 38, the eye care professional can use their National Provider Identifier (NPI) number to log onto the portal and verify patient eligibility and, upon successful approval, can transfer the eye care professional to the inventive web portal for additional credentials to log on and submit an online eyewear prescription order. The patient eligibility may also involve web service interaction between the inventive web portal and a vision care insurance database to confirm if the patient is a valid insurance subscriber.

In step 40, the system receives a prescription from either a physician or the patient. The process then proceeds to step 42 and a determination is made to decide if the prescription is being received directly from the physician or from another source, such as from the patient. If, in step 42, the system determines that the prescription is not received from a physician, the process proceeds to step 44 for verification of the prescription, for example, by either accessing a database of assigned prescriptions for a particular physician group or by contacting the physician group directly.

In step 46, the system determines if the prescription has been verified. If the prescription is not verified, the process proceeds to step 48 and the physician is notified that a prescription was received that could not be verified and, in such a case, the process ends in step 50. If, instead, the prescription is verified in step 46, a verification status is set in step 46 to indicate that the prescription has been verified, and the process proceeds to step 52. Similarly, if in step 42 it is determined that the prescription has been provided by a physician, the process proceeds from step 42 to step 52, in which step a determination is made whether the prescription is for eyewear or contact lenses.

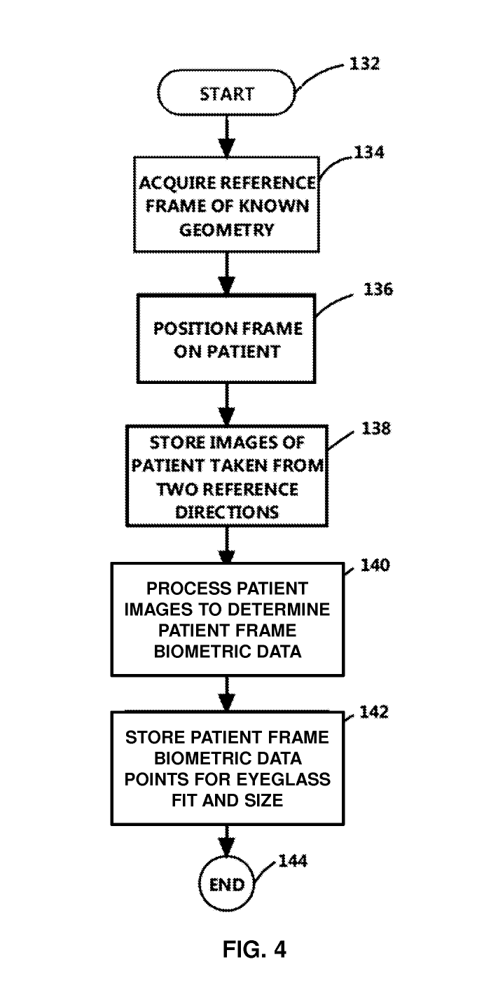

If a determination is made that the prescription is for eyewear in step 52, the process proceeds to step 56 and the system retrieves prescription frame options in step 56. Then, the process in step 56 receives a patient frame selection. In step 60, frame measurement data is retrieved. The frame measurement data may be retrieved either from a manufacture's database or could be by other measures, such as by physical measurement of a selected frame. In step 62, the system receives patient frame biometric measurements, which is detailed in the processes described below with respect to FIG. 4.

In step 68, the system retrieves frame lens options based on the prescription provided. In step 70, the process receives the selection for the type of lens options the patient prefers or has selected and this information is stored for further processing.

If the prescription is not for eyewear, then the process proceeds to step 54 to determine if the prescription is for contact lenses. But, if in step 54 it is determined that the prescription is not for contact lenses, then a notification is sent to the physician in step 48 that the vision device was not specified and the process ends in step 50. With contact lens selected, the process proceeds to step 64, in which the system retrieves contact lens options dependent upon the prescription provided and, in step 66, the patient selects one of the contact lens options and this information is stored for further processing.

Once the patient selection is entered for either contact lenses in step 66 or for eyewear in step 70, the process proceeds to step 88, in which a determination is made for eligibility within the eye care vision plan for either the frames or lenses to be ordered. In step 90, the system automatically submits a claim to the healthcare service provider of the vision plan. The claim may be submitted by a known standard protocol, such as through the Electronic Data Interchange (EDI). Such EDI has standard format data and includes the labels EDI 835, which is submitted to the Insurance Provider, and EDI 837, which is the return receipt for the EDI transfer. In step 92, a determination is made whether payment will be required from the patient. If payment is required, payment is received in step 94 through a payment portal provided through the patient portal 12. Various payment portals are available such as Authorize.net, PAYPAL®, and the like. After payment is received in step 94, the process proceeds to step 96 for order fulfillment. If payment is not required, a determination is made in step 92 to that effect and the process proceeds to step 96 for sending the order to fulfillment. Fulfillment may be either by a frame manufacturer, through which the order is placed, a retailer, or the system may be operable in a retailer's location or frame manufacturer's location so that fulfillment may actually be an order to manufacture a frame in-house. One exemplary embodiment allows the eyeglass lenses to be constructed through 3D image printing. Other options include freeform processing, molding, or other production processes. Then, in step 98, the order is shipped to the patient. The process then ends in step 100.

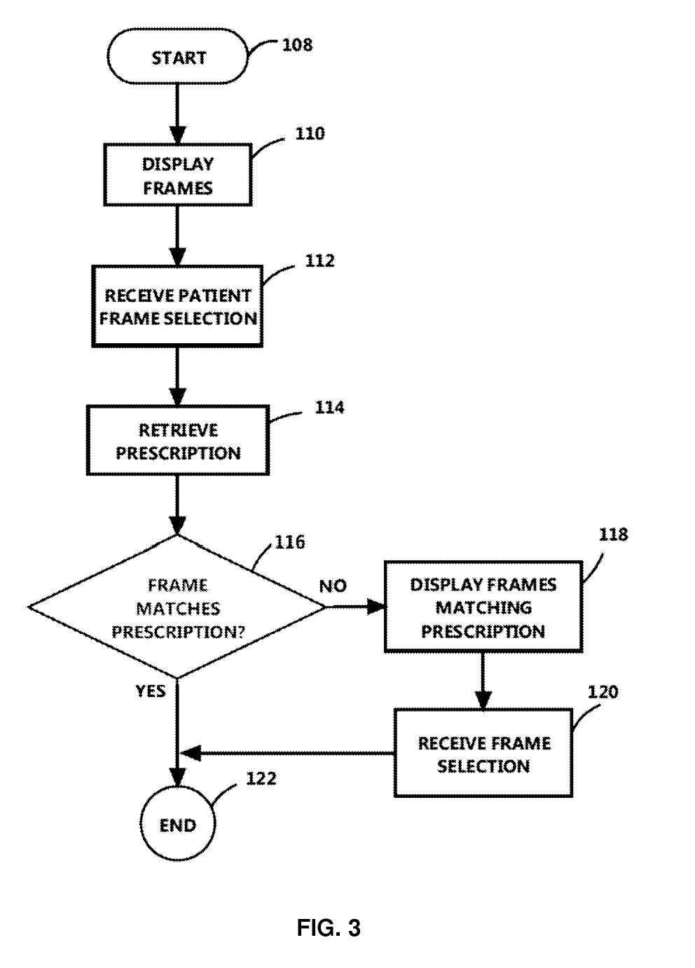

FIG. 3 is a flow chart showing a process for a patient selecting a frame, such as in process steps 56 and 58 in FIG. 2B. In this exemplary embodiment, frame selection process starts in step 108 and proceeds to step 110 in which various frames available from a particular manufacturer or vendor are displayed to the patient. In step 112, the system receives the patient's initial frame selection. The prescription is processed in step 114 and, in step 116, the system determines if the prescription can be matched to the frame selected by the patient. If the prescription cannot be utilized with the selected frame, the process goes to step 118, in which frames are again displayed to the patient, but only those that can be utilized with the prescription supplied. In step 120, a frame selection is received from the patient and the process proceeds to end step 122.

If, in step 116, the prescription is able to be matched to the frame, the process proceeds to end step 122. Similarly, once the frame selection is made, the process proceeds to the end step 122.

Alternatively, the prescription can be required from the patient before displaying any frame to remove any possibility of selecting a frame that does not match the prescription.

FIG. 4 is flow chart depicting a process for automatic collection of patient frame biometric measurements, for example, as in the process step 62. The process begins in step 132. In step 134, a frame of known geometry is acquired and provided for positioning on the patient. The frame may be provided with markings specifically for use as a reference frame, or it can be a general eyeglass frame of known dimensions. The dimensions may be determined by laser frame tracing, or be of known values, for example, from a manufacturer's database. In step 136, the reference frame is placed on the patient. In step 138, images from at least two directions are taken of the patient while wearing the reference frames and are stored for processing. In step 140, the images are processes to determine patient frame biometric data, including values for pupil distance, SEG height, vertex distance, and pantoscopic angle and tilt for eyeglass frames. Relevant patient frame biometric data points are then stored for determining proper eyeglass size and fit for the patient. In other exemplary embodiments, patient frame biometric measurements may be acquired by other measures. Such measures may include placing two reference points of known distance on a patient with a light object of known size. Additionally, images for processing may be acquired by one or more vision system cameras, web cams, smart phone cameras, and the like. Automated frame measurements and patient frame biometric data may be made by utilizing neural network algorithms for determining such frame biometric data as pupil distance, and other frame biometric measurements.

Frame measurement may be accomplished through a laser frame tracer, such as the subject matter contained within U.S. patent application Ser. No. 14/018,311 to Hofineister, filed Sep. 4, 2013, already incorporated by reference herein. Manufacturers' frame measurement databases may also be accessed to acquire frame measurement data. Additionally, a frame trace from a library or other tracers can be submitted along with an order. Alternatively, one of the frame shapes that matches to a frame shape from a known shape library could be submitted to allow eyeglass manufacturing to begin and produce a correct edge thickness.

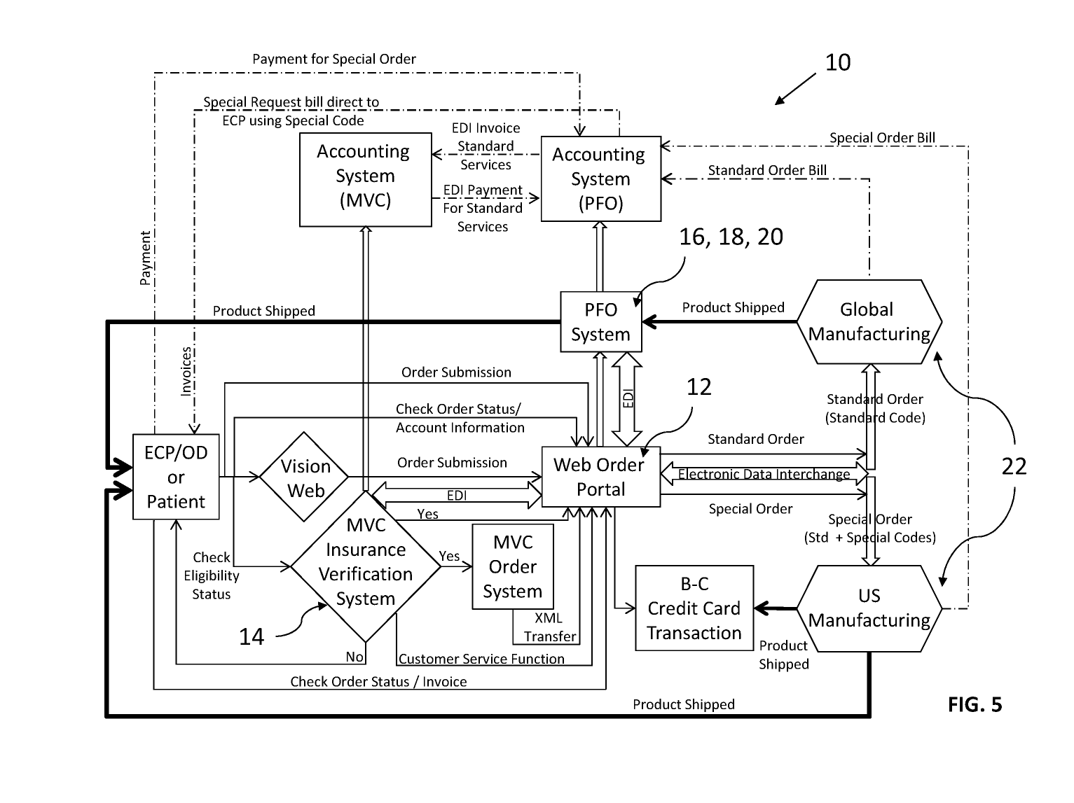

The process flow diagram of FIG. 5 takes all of the above processes and places them in a single vision fulfillment system and method for fulfilling vision orders.

The ordering system 10 is shown, in this exemplary embodiment, as a web order portal, although other connectivity measures are possible. The ordering system 10 has the patient or client portal 12 receiving patient prescriptions, ordering eyeglasses or contact lenses, placing claims for vision care insurance policies, and processing vision care claims to determine coverage eligibility and patient expense calculation.

The ordering system 10 accesses the vision care insurance module 14 interfacing with the insurance providers and determining coverage and eligibility of claims. The frame catalog module 16 interfaces with and obtains frame information from various manufacturers, either directly or through the Internet. The patient portal 12 interfaces with the frame measurement module 18 and with the order and fulfillment module 20. The order fulfillment module 20 then interfaces with the lens production module 22, than can include both Global and U.S. Manufacturers.

The frame measurement module 18 is able to access the manufacturers' databases for frame measurement, automated equipment for measuring frame geometry, and vision systems automatically measuring patient frame biometric data. The automated lens production 22 may include 3D printing of lenses, freeform processing, molding, and other such production processes.

The process flow of FIG. 5 starts with the Eye Care Professional (ECP), the Optometrist (OD), or the patient beginning the process to place an order for eye wear. To first check for the patient's eligibility, the system can use, for example, the Managed Vision Care (MVC) Insurance Verification System. If the patient is eligible, then the order is submitted by the patient portal 12, i.e., the Web Order Portal. If the patient is not eligible, the ECP/OD has the option to submit the order with the patient paying out-of-pocket for the order, or, if the patient is placing the order, the patient can submit payment at that time. The ECP/OD has an option to submit the order via Vision Web (a known online order submission portal) directly into the patient portal 12 of the ordering system 10. Alternately, the ECP/OD can use the MVC portal 14 to fill in the order details and, from this, the order data is transferred via XML transfer to the Web Order Portal 12. Additionally, the MVC system could interface with customer service functions of the ordering system 10 as well as giving the ECP/OD the ability to check a status of an order or look at account information by directly logging into the Web Order Portal 12. The ECP/OD also is provided with a predetermined set of frames in a frame kit. The patient selects one of these predetermined frames to get fitted and adjusted and to mark a pupil location and other frame biometric data, such as pupil distance, seg height, etc. All of the frame biometric data are gathered and submitted directly to the Web Order Portal 12. The ECP/OD also has an option to check the status of an order and to check a status of an invoice directly by accessing the Web Order Portal 12.

The Web Order Portal 12 is communicatively connected to the PFO System 16, 18, 20 and also is communicatively connected to both Global and U.S. Manufacturer labs for submitting a standard order (utilizing standard CPT codes, for example) to a Global Manufacturer lab and for submitting special orders to the U.S. Manufacturer lab. Just to give an example, a Standard Order (as defined herein) may be frames for single vision and may include only a few progressive frame designs. Likewise, a Special Order may include many branded progressive designs. Additionally, both the Global and U.S. Manufacturer labs mentioned have, in stock, a predetermined set of frames that are identifiable by numbers and that match the frames that the ECP/OD has demonstrated to the patient, who has been fitted, and to whom, based upon the fitting, data has been transferred through Web Order Portal.

As indicated with the heavy lines in FIG. 5, the Global or U.S. Manufacturer ships uncut lenses, edged lenses, lenses mounted in frames, or processed lenses as desired by the ECP/OD to either the main facility or directly to the office of the ECP/OD, which receiving office dispenses the completed eyewear to the patient. In contrast to frames, contact lenses are directly shipped to the patient or to the ECP/OD once credit card transactions are approved.

Electronic Data Interchange (EDI) connections, which facilitates transfer of data in a standard format, are indicated in FIG. 5 with broad arrows, such as the connection between MVC and the Web Order Portal 12 and between the Web Order Portal 12 and either of the Global or U.S. Manufacturers.

Accounting processes (including billing, invoicing, and the like) are indicated with dash-dot arrows in FIG. 5. The Accounting System (PFO) of the ordering system 10 accepts a standard order bill and a special order bill from the Global and U.S. Manufacturer labs and then submits an invoice or EDI to the MVC or ECP/OD directly. The PFO System is connected to the Accounting System (PFO), which communicates with the MVC Accounting system to submit claims, for example, via EDI 835 and obtain a response back as EDI 837 from the MVC system. The PFO System also is able to handle split billing and send an invoice to the ECP/OD for the special codes and accepts payments from both ECP/OD and MVC.

Advantages described herein provide an online eyeglasses and/or contact lens ordering system. A patient portal is provided for use on a personal computing device or an in-store kiosk, providing a self-service system reducing costs for providing eyeglasses and contact lenses to consumers.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” may be used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An online lens ordering system, comprising:
a computer providing:
a patient portal allowing a user to enter:
at least one of identifying information and healthcare plan information; and
a purchase selection for one of:
eyeglasses including a prescription, a selected frame and lenses to be fabricated; and
contact lenses including a prescription;
a vision plan eligibility module:
submitting claims to an insurer based upon the healthcare plan information;
determining an amount due by the patient, if any, based upon the purchase selection; and
one of:
receiving payment of the amount due from the patient if an amount is due and then setting an order authorization; and
setting the order authorization if an amount is not due; and
a fulfillment module that:
upon receiving the order authorization for eyeglasses:
obtains the patient's prescription and frame biometric measurements; and
automatically orders the selected frame and fabrication of the lenses based upon the prescription and delivering a fabricated pair of the eyeglasses either directly to the patient or to an eye care professional business; and
upon receiving the order authorization for contact lenses, automatically orders delivery of the contact lenses based on the prescription either directly to the patient or to an eye care professional business.

2. The online lens ordering system according to claim 1, wherein the computing device is a personal computing device, an in-store kiosk, and/or a handheld device.

3. The online lens ordering system according to claim 1, wherein the patient portal is an Internet connection enabling the user to access information, sites, programs, and databases available through the Internet.

4. The online lens ordering system according to claim 1, wherein the identifying information includes at least one of contact data for a patient, patient identification, contact data for an eye care professional, a National Provider Identifier number, contact data for a user, and/or factual data sufficient to verify eligibility to fulfill the patient's vision prescription.

5. The online lens ordering system according to claim 1, wherein the healthcare plan information includes at least one of contact data for the patient, a plan number, an employee number, a patient identification number, contact data for the eye care professional, contact data for the professional who provided and/or generated the prescription, contact data for the healthcare plan provider, and/or information sufficient to submit a claim with the healthcare plan provider.

6. The online lens ordering system according to claim 1, wherein the vision plan eligibility module interfaces with an insurer through the Internet to submit the claim and determine if any amount is due by the patient.

7. The online lens ordering system according to claim 1, wherein the fulfillment module sends the order authorization to an automated lens production module that accesses manufacturers' databases for frame data to fabricate the lenses.

8. The online lens ordering system according to claim 1, wherein the fulfillment module retrieves frame measurement data from a database, the frame tracer, or the identifying information and utilizes the frame measurement data along with the prescription to fabricate the lenses.

9. The online lens ordering system according to claim 8, wherein the fulfillment module is communicatively connected to a lens fabrication device that fabricates based upon the prescription and frame measurement data.

10. The online lens ordering system according to claim 1, wherein the fulfillment module is communicatively connected to a frame tracing device that creates frame data by scanning the selected frame from an inventory and utilizes the frame data and the prescription for fabricating the complete eyewear.

11. The online lens ordering system according to claim 10, wherein the fulfillment module is communicatively connected to a lens fabrication device that fabricates based upon the frame data and the prescription.

12. The online lens ordering system according to claim 7, wherein the automated lens production module is communicatively connected to off-site lens fabrication labs through the Internet.

13. The online lens ordering system according to claim 1, wherein the fulfillment module is communicatively connected to a contact lens distribution site through the Internet and automatically populates data into data entry fields of the contact lens distribution site.

14. The online lens ordering system according to claim 1, wherein the contact lens distribution site is a contact lens distributor or a contact lens manufacturer.

15. The online lens ordering system according to claim 1, wherein the fulfillment module is communicatively connected to laboratory management software and obtains real-time status updates on orders submitted.

16. The online lens ordering system according to claim 1, wherein:
the identifying information includes factual data sufficient to fulfill the patient's vision prescription; and
the patient portal module is communicatively connected to a prescription verification site through the Internet and verifies the patient's vision prescription.

17. The online lens ordering system according to claim 1, wherein the fulfillment module automatically captures the patient's frame biometric measurements with a pre-determined frame using a vision detecting system and, based upon the patient's prescription and biometric measurements taken, produces the complete eyewear.

18. The online lens ordering system according to claim 1, wherein the fulfillment module:
automatically captures the patient's frame biometric measurements by acquiring a reference frame of known geometry provided for positioning on the patient, the fulfillment module having access to the dimensions of the reference frame;
stores images from at least two directions of the patient while wearing the reference frame; and
processes the images to determine the patient's frame biometric measurements.

19. The online lens ordering system according to claim 1, wherein the frame biometric measurements comprise values for pupil distance, SEG height, vertex distance, and pantoscopic angle and tilt.

20. The online lens ordering system according to claim 1, further comprising an automatic eyeglass sizing device automatically sizing eyeglasses for a patient, the automatic eyeglass sizing device comprising a neural network and an associated database containing frame sizing and fit data.

21. The online lens ordering system according to claim 1, further comprising a lens fabrication device automatically producing lenses, the lens fabrication device comprising at least one of 3D printing processes, freeform processing, and/or molding processes.

22. An online lens ordering system, comprising:
a patient portal is provided for use on a personal computing device, an in-store kiosk, and/or a handheld device, wherein a patient enters identifying information and optional healthcare plan information, and either eyeglasses or contact lenses are selected using the lens ordering system;
means for determining vision plan eligibility, submitting claims, submitting a prescription, and determining an amount due, and receiving payment the amount due from the patient;
means for automatically sizing eyeglasses for a patient, using a vision system with a known frame size to capture patient frame biometric measurements; and
means for ordering fabrication and delivery of eyeglasses and/or contact lenses either directly to the patient or to an eye care professional business.

23. The online lens ordering system according to claim 22, further comprising the means for automatically sizing eyeglasses for a patient including a neural network and associated database containing frame sizing and fit data.

24. The online lens ordering system according to claim 23, further comprising means for fabricating lenses using automated lens production which includes at least one of 3D printing, freeform processing, molding, and other such production processes.
